(19) United States
(12) Patent Application Publication
(10) Pub. No.: US 2018/0137762 A1
(43) Pub. Date: May 17, 2018

(54) START CONTROL DEVICE AND METHOD FOR VEHICLE

(71) Applicant: HYUNDAI MOTOR COMPANY, Seoul (KR)

(72) Inventors: KYOUNG JUN LEE, SEOUL (KR); CHANG HO KIM, SEOUL (KR)

(73) Assignee: HYUNDAI MOTOR COMPANY, Seoul (KR)

(21) Appl. No.: 15/477,493

(22) Filed: Apr. 3, 2017

(30) Foreign Application Priority Data
Nov. 15, 2016 (KR) 10-2016-0152070

(51) Int. Cl. G08G 1/00; B60Q 1/52; B60K 31/00; B60T 8/1755; B60T 8/32; B60R 25/24; B60Q 9/00

(52) U.S. Cl. CPC G08G 1/22; B60Q 1/525; B60K 31/0008; B60T 8/1755; B60W 2050/048; B60R 25/24; B60Q 9/008; B60W 2550/402; B60T 8/32

(57) ABSTRACT

The present disclosure relates to a start control device and method for a vehicle. The start control device for a vehicle includes: when the vehicle stops, a danger zone determining unit configured to determine a danger zone based on information about surroundings of the vehicle; a time limit setting unit configured to set a time limit for automatic start of the vehicle based on whether the vehicle is in the danger zone; and a driving control unit configured to control a start of the vehicle based on a distance between the vehicle and a preceding vehicle, where the driving control unit is configured to control the start of the vehicle based on the time limit for automatic start when the preceding vehicle starts after the vehicle stops.

### CROSS-REFERENCE TO RELATED APPLICATION

The present application claims priority to and the benefit of Korean Patent Application No. 10-2016-0152070, filed on Nov. 15, 2016, which is incorporated herein by reference in its entirety.

### FIELD

The present disclosure relates to a start control device and method for a vehicle.

### BACKGROUND

The statements in this section merely provide background information related to the present disclosure and may not constitute prior art.

A vehicle-to-vehicle distance control system of an automated vehicle controls the subject vehicle to automatically stop when a preceding vehicle stops. In addition, when the preceding vehicle starts in the state in which the subject vehicle is stopped, the vehicle-to-vehicle distance control system controls the start of the subject vehicle only if a vehicle operator operates a switch or button or an accelerator pedal after a predetermined period of time has elapsed.

However, in the vehicle-to-vehicle distance control system according to the related art, the predetermined period of time that is set as a default value when the vehicle is stopped is within three seconds, which is very short. If the vehicle is frequently stopped due to traffic congestion, it is desired to operate the switch or button, the accelerator pedal, and the like whenever the vehicle operator starts the vehicle, causing inconvenience.

In addition, if the preceding vehicle starts within the predetermined period of time, the vehicle-to-vehicle distance control system according to the related art controls the subject vehicle to automatically start irrespective of potentially dangerous situations around the vehicle, causing difficulties in avoiding the dangerous situations.

### SUMMARY

An aspect of the present disclosure provides a start control device and method for a vehicle, which may be designed to control the automatic start of the vehicle by determining dangerous situations around the vehicle in a state in which the vehicle is stopped.

An aspect of the present disclosure also provides a start control device and method for a vehicle, which may be designed to variably set a time limit for automatic start of the vehicle.

According to an aspect of the present disclosure, a start control device for a vehicle includes: when the vehicle stops, a danger zone determining unit configured to determine a danger zone based on information regarding a surrounding of the vehicle; a time limit setting unit configured to set a time limit for automatic start of the vehicle based on whether the vehicle is in the danger zone; and a driving control unit configured to control a start of the vehicle based on a distance between the vehicle and a preceding vehicle, where the driving control unit is configured to control the start of the vehicle based on the time limit for automatic start when the preceding vehicle starts after the vehicle stops.

According to another aspect of the present disclosure, a start control method for a vehicle includes: determining whether the vehicle is stopped is in a danger zone based on information about surroundings of the vehicle; setting a time limit for automatic start of the vehicle based on whether the vehicle is in the danger zone; determining whether the time limit for automatic start has been set when a preceding vehicle starts after the vehicle stops; and controlling a start of the vehicle based on the time limit for automatic start when it is determined that the time limit for automatic start has been set.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates the configuration of a start control device for a vehicle;

FIGS. 2A to 3 illustrate the operations of a start control device for a vehicle;

FIGS. 4 and 5 illustrate flowcharts of a start control method for a vehicle; and

FIG. 6 illustrates the configuration of a computing system by which a start control method for a vehicle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

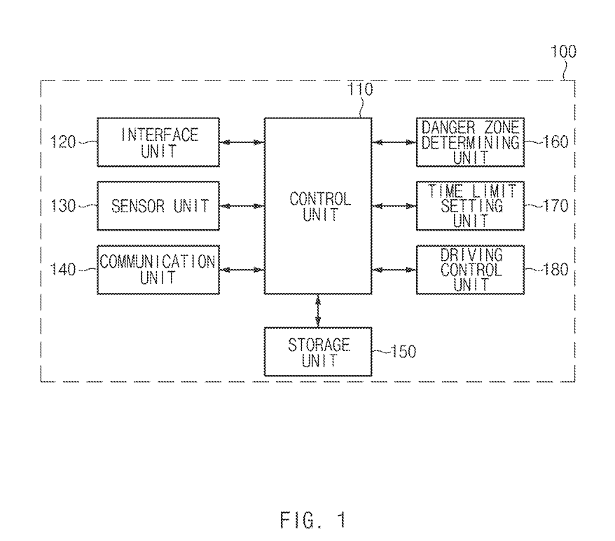

FIG. 1 illustrates the configuration of a start control device for a vehicle, according to some forms of the present disclosure.

A start control device 100 for a vehicle, according to one form of the present disclosure, may be provided inside of the vehicle. The start control device 100 for a vehicle may be integrated with internal control units, or may be provided as a separate device that is connected to vehicle control units through separate connecting members. Here, the start control device 100 for a vehicle may be interlocked with a navigation device, an engine, a motor, a brake, an accelerator, and the like, or may be interlocked with control units that control the operations of the engine, the motor, the brake, and the accelerator.

Referring to FIG. 1, the start control device 100 for a vehicle includes a control unit 110, an interface unit 120, a sensor unit 130, a communication unit 140, a storage unit 150, a danger zone determining unit 160, a time limit setting unit 170 and a driving control unit 180. Here, the control unit 110 may process signals transmitted between elements of the start control device 100 for a vehicle.

The interface unit 120 includes an input unit receiving a control command from a user and an output unit outputting the operating states and results of the start control device 100 for a vehicle.

Here, the input unit includes a key button, a mouse, a joystick, a jog shuttle, and a stylus pen. In addition, the input unit includes soft keys displayed on a display screen.

The output unit includes a display unit, and also includes an audio output unit such as a speaker. When a touch sensor, such as a touch film, a touch sheet, or a touch pad, is provided in the display unit, the display unit may serve as a touch screen and may have the input unit and the output unit in an integrated form.

For example, the display unit may display a time limit setting on the touch screen. When a + button or a − button on the touch screen is touched by a vehicle operator, the display unit may output information of the touched button on the touch screen.

In addition, the display unit may display an automatic start limit notification. In addition, the display unit may display a message for asking whether to start the vehicle on the touch screen. When the vehicle operator inputs a start command through the touch screen, the display unit may output information about the start command input by the vehicle operator.

Here, the display unit includes at least one of a liquid crystal display (LCD), a thin film transistor liquid crystal display (TFT LCD), an organic light emitting diode (OLED), a flexible display, a field emission display (FED), and a three dimensional (3D) display.

The sensor unit 130 includes at least one sensor detecting an obstacle around the vehicle and measuring a distance between the vehicle and the corresponding obstacle. For example, the sensor unit 130 includes an ultrasonic sensor, a radio detection and ranging (RADAR) sensor, a light detection and ranging (LiDAR) sensor, a scanner, and a camera. Any sensor able to detect an obstacle or measure a distance from the obstacle may be used. Here, the obstacle may be a pedestrian, a bicycle, a motorcycle, or another vehicle around the vehicle, and may also be any moving object that may potentially collide with the vehicle.

The communication unit 140 includes a communication module supporting a communication interface with electric/electronic devices and/or control units. For example, the communication module may communicate with the navigation device mounted in the vehicle to receive information about the surroundings of the vehicle, such as structures around the vehicle and road attributes, from the navigation device.

Here, the communication module includes a module supporting in-vehicle network communications such as controller area network (CAN) communication, local interconnect network (LIN) communication, and Flex-Ray communication.

In addition, the communication unit 140 includes a communication module supporting V2V communications with neighboring vehicles. For example, the communication module may receive movement information of neighboring vehicles through V2V communications, and may also receive information about the surroundings.

Here, the communication module includes a module for wireless internet connection or a module for short range communication. Wireless internet technology includes Wireless LAN (WLAN), Wireless Broadband (Wibro), Wi-Fi, and World Interoperability for Microwave Access (Wimax), and short range communication technology includes Bluetooth, ZigBee, Ultra Wideband (UWB), Radio Frequency Identification (RFID), and Infrared Data Association (IrDA).

The storage unit 150 may store data and/or algorithms required for operating the start control device 100 for a vehicle.

The storage unit 150 may store the surrounding information obtained by the sensor unit 130, and may also store the information received from the navigation device through the communication unit 140 and/or the information received from the neighboring vehicles through V2V communication. In addition, the storage unit 150 may store a command and/or an algorithm for determining a danger zone for automatic start and setting a time limit for automatic start.

Here, the storage unit 150 includes a storage medium such as a random access memory (RAM), a static random access memory (SRAM), a read-only memory (ROM), a programmable read-only memory (PROM), or an electrically erasable programmable read-only memory (EEPROM).

The driving control unit 180 may automatically control a start or stop of the subject vehicle by controlling a distance between the subject vehicle and a preceding vehicle (i.e., vehicle-to-vehicle distance control).

When the subject vehicle is stopped by the driving control unit 180 during automated driving because of the stop of the preceding vehicle, the danger zone determining unit 160 may determine a danger zone for automatic start on the basis of the surroundings of the vehicle. Here, the danger zone determining unit 160 may determine whether or not a zone in which the vehicle is stopped is the danger zone for automatic start, while considering all information including the surrounding information obtained from the sensor unit 130, the surrounding information obtained from the navigation device, and the surrounding information received from the communication unit 140.

Here, the danger zone determining unit 160 may determine whether the zone in which the subject vehicle is stopped is a danger zone or a safety zone for automatic start, according to whether or not a road on which the vehicle is stopped is a road for the exclusive use of vehicles, and whether or not there is a crosswalk, a crossroad, an object of protection, or a moving object in a surrounding area within a predetermined distance from the vehicle. Here, the object of protection may be a pedestrian, a bicycle, or a motor cycle, and the moving object may be any object that moves around the vehicle and potentially collides with the vehicle due to the starting of the vehicle. For example, the moving object may be another vehicle cut in front of the vehicle.

For example, if the vehicle is stopped on the road for the exclusive use of vehicles, the danger zone determining unit 160 may determine the zone in which the vehicle is stopped as the safety zone for automatic start.

Meanwhile, if there is a crosswalk, a crossroad, an object of protection, or a moving object in a surrounding area within a predetermined distance from the vehicle, the danger zone determining unit 160 may determine the zone in which the vehicle is stopped as the danger zone for automatic start.

When it is determined that the zone in which the vehicle is stopped is the danger zone for automatic start, the time limit setting unit 170 may set a time limit for automatic start.

Here, the time limit setting unit 170 may configure and display a time limit setting for automatic start (hereinafter referred to as “automatic start time limit setting”) on the display screen, and set a time limit for automatic start on the basis of input information according to the vehicle operator's operation.

Meanwhile, the time limit setting unit 170 may set the time limit for automatic start to a first set value that is predetermined by the vehicle operator or a manager.

When the time limit for automatic start is set to the predetermined first set value, the time limit setting unit 170 may variably set the predetermined time limit for automatic start upon request of the vehicle operator.

When it is determined that the zone in which the vehicle is stopped is the safety zone for automatic start rather than the danger zone for automatic start, the time limit setting unit 170 may not set the time limit for automatic start. However, if the time limit for automatic start has been previously set, the time limit setting unit 170 may initialize the previously set time limit for automatic start to cancel the setting of the time limit for automatic start.

In addition, when it is determined that the zone in which the vehicle is stopped is the safety zone for automatic start rather than the danger zone for automatic start, the time limit setting unit 170 may set the time limit for automatic start to a second set value greater than the first set value. For example, the second set value may be infinite.

Here, when the setting of the time limit for automatic start is completed, the time limit setting unit 170 may configure and display the automatic start limit notification on the display screen.

The driving control unit 180 may control the start or stop of the subject vehicle by controlling a distance between the subject vehicle and the preceding vehicle (i.e., vehicle-to-vehicle distance control). When the preceding vehicle starts in the state in which the subject vehicle is stopped, the driving control unit 180 may determine whether or not the time limit for automatic start has been set. If the time limit for automatic start has not been set, the driving control unit 180 may control the start of the subject vehicle by controlling the distance between the subject vehicle and the preceding vehicle.

Meanwhile, if the time limit for automatic start has been set, the driving control unit 180 may determine whether or not the previously set time limit for automatic start has elapsed. If the time limit for automatic start has not elapsed, the driving control unit 180 may control the start of the subject vehicle by controlling the distance between the subject vehicle and the preceding vehicle.

For example, when the time limit for automatic start is set to the second set value, the time limit for automatic start has not elapsed until the preceding vehicle starts. Therefore, the driving control unit 180 may control the start of the subject vehicle by controlling the distance between the subject vehicle and the preceding vehicle when the preceding vehicle starts.

For example, when the time limit for automatic start is set to ten seconds and the preceding vehicle starts within ten seconds after being stopped, the driving control unit 180 may control the start of the subject vehicle by controlling the distance between the subject vehicle and the preceding vehicle.

If the time limit for automatic start has already elapsed at a point in time at which the preceding vehicle starts, the driving control unit 180 may limit the start of the vehicle. Here, the driving control unit 180 may output a message for asking whether to start the vehicle on the display screen. In this case, the driving control unit 180 may control the vehicle to start if the start command is input by the vehicle operator, and maintain the vehicle in a stopped state if not.

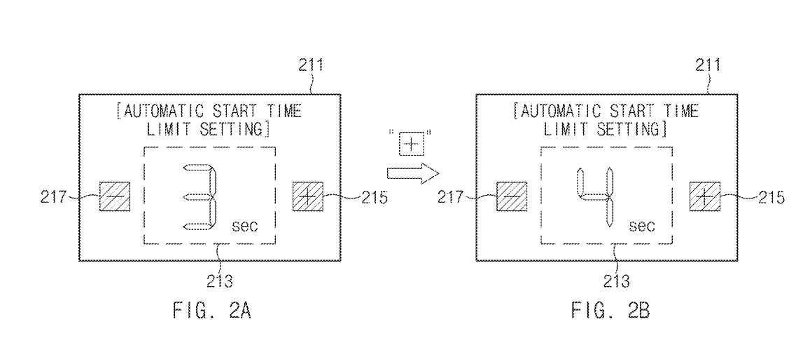

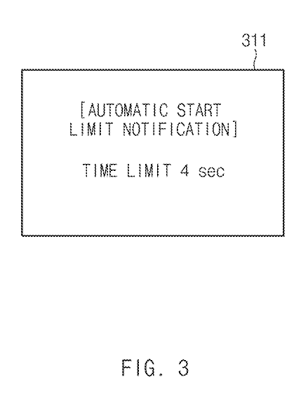

FIGS. 2A to 3 illustrate the operations of a start control device for a vehicle, according to some forms of the present disclosure.

FIGS. 2A and 2B illustrate the setting of a time limit for automatic start, according to one form of the present disclosure.

When it is determined that a zone in which the vehicle is stopped is a danger zone for automatic start, the start control device 100 for a vehicle may configure and display an automatic start time limit setting 211 on the display screen as illustrated in FIG. 2A.

Here, time information may be displayed in a first area 213 of the automatic start time limit setting 211. In addition, +/− buttons 215 and 217 may be disposed adjacently to the first area 213 to adjust a setting time.

When the +/− buttons 215 and 217 are operated by the vehicle operator, the start control device 100 for a vehicle may revise a number displayed on the first area 213 by an amount equal to the number of operations of the +/− buttons 215 and 217 and display the revised number.

For example, in a state in which “3 sec” is displayed in the first area 213 of the automatic start time limit setting 211 as illustrated in FIG. 2A, when the + button 215 is operated once by the vehicle operator, the start control device 100 for a vehicle may revise the number displayed in the first area 213 to four (4) and display “4 sec” as illustrated in FIG. 2B.

The start control device 100 for a vehicle may set a time limit for automatic start on the basis of the number ultimately selected by the vehicle operator.

FIG. 3 illustrates the notification of information about a time limit for automatic start, according to one form of the present disclosure.

If a time limit for automatic start has been set since it is determined that a zone in which the vehicle is stopped is a danger zone for automatic start, the start control device 100 for a vehicle may configure and display an automatic start limit notification 311 on the display screen as illustrated in FIG. 3. Therefore, the vehicle operator may easily recognize an automatic start limit situation from the automatic start limit notification 311.

FIG. 3 illustrates an example of the automatic start limit notification 311 by which the vehicle operator is notified of the automatic start limit situation, but the present inventive concept is not limited thereto. For example, the automatic start limit situation may be notified by a sound from a speaker.

The operations of the start control device for a vehicle designed to have the above-described configuration will be described in more detail below.

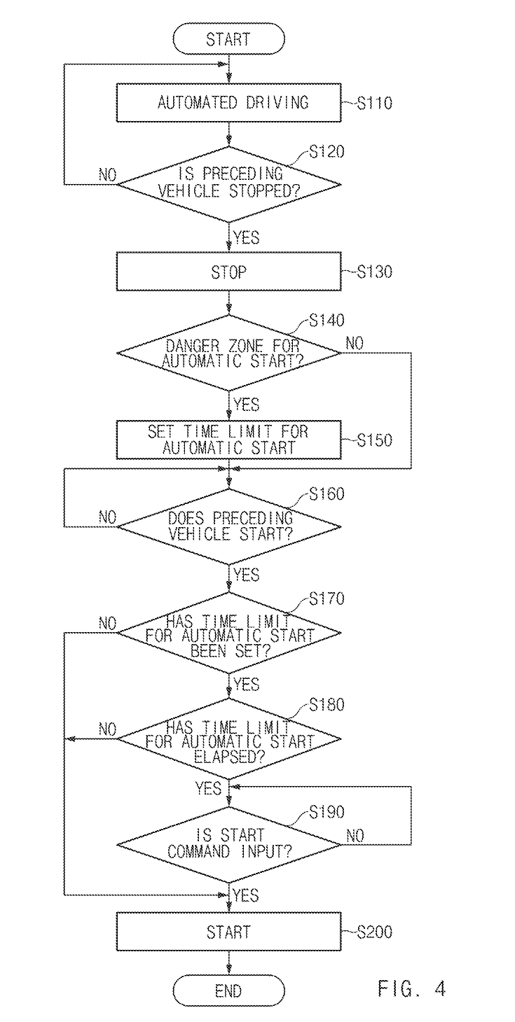

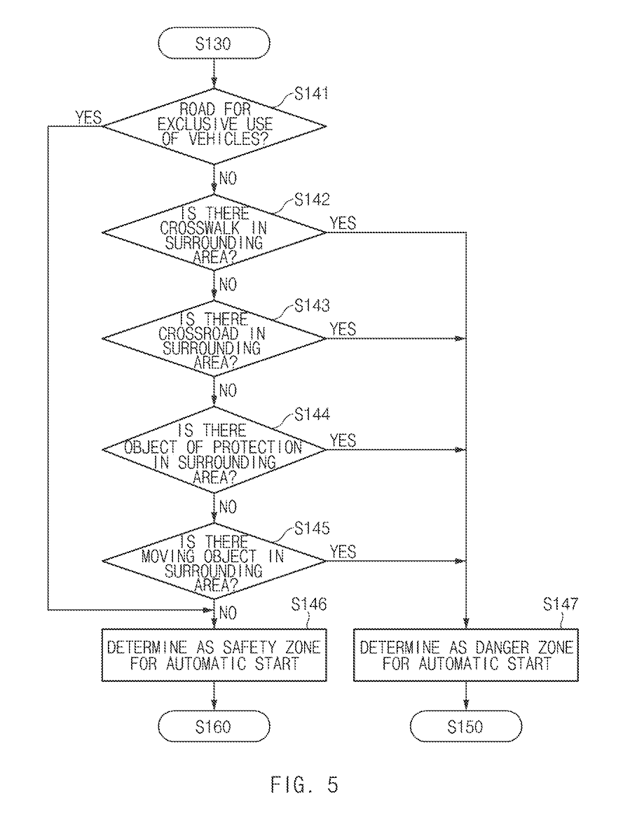

FIGS. 4 and 5 illustrate flowcharts of a start control method for a vehicle, according to some forms of the present disclosure.

As illustrated in FIG. 4, when a subject vehicle is in automated driving mode in step S110 and a preceding vehicle is stopped in step S120, the start control device 100 for a vehicle may control the subject vehicle to stop in step S130.

When the subject vehicle is stopped, the start control device 100 for a vehicle may determine whether or not a zone in which the vehicle is stopped is a danger zone for automatic start on the basis of information about the surroundings of the vehicle in step S140.

When it is determined that the zone in which the vehicle is stopped is the danger zone for automatic start in step S140, the start control device 100 for a vehicle may set a time limit for automatic start in step S150.

In step S150, the start control device 100 for a vehicle may set the time limit for automatic start according to an input value through an automatic start time limit setting, or may set the time limit for automatic start according to a predetermined first set value. Here, a vehicle operator may operate +/− buttons of the time limit setting on display according to the surroundings, to thereby adjust the time limit for automatic start.

Meanwhile, when it is determined that the zone in which the vehicle is stopped is a safety zone for automatic start rather than the danger zone for automatic start in step S140, the start control device 100 for a vehicle may omit step S150 and perform step S160.

Although not shown in FIG. 4, if the time limit for automatic start has been previously set, the start control device 100 for a vehicle may initialize the previously set time limit for automatic start to cancel the setting of the time limit for automatic start, or may set the time limit for automatic start to a second set value (infinite) greater than the first set value and then perform step S160.

Thereafter, when the preceding vehicle starts in step S160, the start control device 100 for a vehicle may determine whether or not the time limit for automatic start has been set in step S170. If the time limit for automatic start has not been set in step S170, the start control device 100 for a vehicle may control a distance between the subject vehicle and the preceding vehicle (i.e., vehicle-to-vehicle distance control) to control the subject vehicle to start in step S200.

Meanwhile, if the time limit for automatic start has been set in step S170, the start control device 100 for a vehicle may determine whether or not the previously set time limit for automatic start has elapsed in step S180. If the time limit for automatic start has not elapsed in step S180, the start control device 100 for a vehicle may control a distance between the subject vehicle and the preceding vehicle (i.e., vehicle-to-vehicle distance control) to control the subject vehicle to start in step S200. On the other hand, if the time limit for automatic start has elapsed in step S180, the start control device 100 for a vehicle may limit the start of the subject vehicle until a start command is input by the vehicle operator. When the start command is input by the vehicle operator in step S190, the start control device 100 for a vehicle may control the vehicle to start in step S200.

FIG. 5 illustrates details of step S140 of determining the danger zone for automatic start.

The start control device 100 for a vehicle may determine whether a zone in which the vehicle is stopped is a danger zone or a safety zone for automatic start, according to information about the surroundings of the vehicle, for example, whether or not a road on which the vehicle is stopped is a road for the exclusive use of vehicles, and whether or not there is a crosswalk, a crossroad, an object of protection, or a moving object in a surrounding area within a predetermined distance from the vehicle. Here, the information about the surroundings of the vehicle may be obtained by the sensors and the navigation device mounted in the vehicle or through V2V communications with neighboring vehicles.

As illustrated in FIG. 5, the start control device 100 for a vehicle may determine whether or not the road on which the vehicle is stopped is a road for the exclusive use of vehicles in step S141. When it is determined that the road on which the vehicle is stopped is a road for the exclusive use of vehicles in step S141, the start control device 100 for a vehicle may determine the zone in which the vehicle is stopped as the safety zone for automatic start in step S146, and perform the steps after step S160 of FIG. 4.

Meanwhile, when it is determined that the road on which the vehicle is stopped is not a road for the exclusive use of vehicles in step S141, the start control device 100 for a vehicle may determine whether or not there is a crosswalk, a crossroad, an object of protection, or a moving object in a surrounding area within a predetermined distance from the vehicle in steps S142 to S145. When it is determined that there is a crosswalk, a crossroad, an object of protection, or a moving object in a surrounding area within a predetermined distance from the vehicle in steps S142 to S145, the start control device 100 for a vehicle may determine the zone in which the vehicle is stopped as the danger zone for automatic start in step S147, and perform the steps after step S150 of FIG. 4.

The start control device 100 for a vehicle operating as described above may be configured as an independent hardware device. It may be operated as at least one processor that is included in another hardware device such as a microprocessor or a general-purpose computer system.

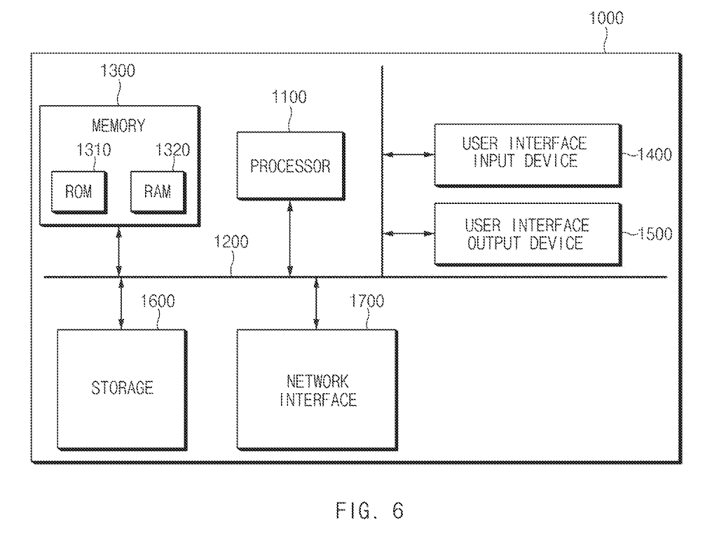

FIG. 6 illustrates the configuration of a computing system by which a start control method for a vehicle according to one form of the present disclosure.

Referring to FIG. 6, a computing system 1000 includes at least one processor 1100, a bus 1200, a memory 1300, a user interface input device 1400, a user interface output device 1500, a storage 1600, and a network interface 1700, wherein these elements are connected through the bus 1200.

The processor 1100 may be a central processing unit (CPU) or a semiconductor device processing commands stored in the memory 1300 and/or the storage 1600. The memory 1300 and the storage 1600 include various types of volatile or non-volatile storage mediums. For example, the memory 1300 includes a read only memory (ROM) and a random access memory (RAM).

Therefore, the steps of the method or algorithm described herein may be embodied directly in a hardware module or a software module that is executed by the processor 1100, or a combination of both. The software module may reside in storage mediums, i.e., the memory 1300 and/or the storage 1600, such as RAM, a flash memory, ROM, EPROM, EFPROM, a register, a hard disk, a removable disk, and a CD-ROM. The exemplary storage medium may be coupled to the processor 1100, such that the processor 1100 may read information from the storage medium and write information to the storage medium. Alternatively, the storage medium may be integrated with the processor 1100. The processor 1100 and the storage medium may reside in an application specific integrated circuit (ASIC). The ASIC may reside in a user terminal. Alternatively, the processor 1100 and the storage medium may reside as individual components in a user terminal.

As set forth above, the start control device and method for a vehicle, according to some forms of the present disclosure, may be designed to limit the automatic start of the vehicle by determining potentially dangerous situations around the vehicle in the state in which the vehicle is stopped, thereby avoiding the potentially dangerous situations. In addition, the start control device and method for a vehicle, according to some forms of the present disclosure, may be designed to variably set the time limit for automatic start of the vehicle, thereby reducing frequent operations of the vehicle operator and the inconvenience as well.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A start control device for a vehicle, the start control device comprising:
when the vehicle stops, a danger zone determining unit configured to determine a danger zone based on information regarding a surrounding of the vehicle;
a time limit setting unit configured to set a time limit for automatic start of the vehicle based on whether the vehicle is in the danger zone; and
a driving control unit configured to control a start of the vehicle based on a distance between the vehicle and a preceding vehicle, wherein, when the preceding vehicle starts after the vehicle stops, the driving control unit is configured to control the start of the vehicle based on the time limit for automatic start.

2. The start control device according to claim 1, wherein the danger zone determining unit is further configured to:
when the vehicle is on a road exclusively designated for vehicles, determine that the vehicle is in a safety zone for automatic start; and
when there are obstacles, determine that the vehicle is in the danger zone, wherein the obstacles comprise a crosswalk, a crossroad, an object of protection, or a moving object in a surrounding area within a predetermined distance from the vehicle.

3. The start control device according to claim 1, wherein the time limit setting unit is configured to display an automatic start time limit setting on a display screen, and to set the time limit for automatic start when a vehicle operator inputs information through the automatic start time limit setting.

4. The start control device according to claim 3, wherein the automatic start time limit setting is configured to adjust a time displayed in a first area, wherein the automatic start time limit setting comprises time information displayed in the first area, and +/− buttons disposed adjacently to the first area.

5. The start control device according to claim 1, wherein the time limit setting unit is configured to set the time limit for automatic start based on a predetermined first set value.

6. The start control device according to claim 5, wherein the time limit setting unit is configured to variably set the time limit for automatic start upon request by the vehicle operator.

7. The start control device according to claim 1, wherein, when setting the time limit for automatic start of the vehicle is completed, the time limit setting unit is configured to display an automatic start limit notification on a display screen.

8. The start control device according to claim 1, wherein, when it is determined that the vehicle is in the safety zone for automatic start and the time limit for automatic start has been previously set, the time limit setting unit is configured to cancel setting the time limit for automatic start of the vehicle by initializing the time limit for automatic start that has been previously set.

9. The start control device according to claim 1, wherein, when it is determined that the vehicle is in the safety zone for automatic start and the time limit for automatic start has been previously set, the time limit setting unit is configured to set the time limit for automatic start to a predetermined second set value.

10. The start control device according to claim 9, wherein the second set value is infinite.

11. The start control device according to claim 1, wherein, when the preceding vehicle starts after the vehicle stops, the driving control unit is configured to determine whether the time limit for automatic start has elapsed from a point that the vehicle stopped.

12. The start control device according to claim 11, wherein, when it is determined that the time limit for automatic start has not elapsed from the point that the vehicle stopped, the driving control unit is configured to control the start of the vehicle based on the distance between the vehicle and the preceding vehicle.

13. The start control device according to claim 11, wherein, when it is determined that the time limit for automatic start has elapsed from the point that the vehicle stopped, the driving control unit is configured to hold the start of the vehicle until the vehicle operator inputs a start command.

14. The start control device according to claim 13, wherein the driving control unit is configured to output a message on a display screen, wherein the message asks the vehicle operator whether to start the vehicle, and to control the start of the vehicle when the vehicle operator inputs the start command.

15. The start control device according to claim 1, wherein, when the time limit for automatic start has not been previously set, the driving control unit is configured to control the start of the vehicle based on the distance between the vehicle and the preceding vehicle when the preceding vehicle starts.

16. The start control device according to claim 1, further comprising:
a sensor unit configured to detect first surrounding information of the vehicle, wherein the first surrounding information of the vehicle comprises information about a pedestrian, a bicycle, a motor cycle, or another vehicle located in a surrounding area of the vehicle.

17. The start control device according to claim 1, further comprising:
a communication unit configured to receive second surrounding information of the vehicle, wherein the second surrounding information of the vehicle comprises information about movements of neighboring vehicles based on V2V communications with the preceding vehicle or another vehicle located in the surrounding area of the vehicle.

18. The start control device according to claim 17, wherein the communication unit is configured to communicate with a navigation device mounted in the vehicle and to receive third surrounding information of the vehicle, wherein the third surrounding information of the vehicle comprises information about road conditions in the surrounding area of the vehicle.

19. A start control method for a vehicle, the start control method comprising:
determining whether the vehicle is in a danger zone based on information about surroundings of the vehicle;
setting a time limit for automatic start of the vehicle based on whether the vehicle is in the danger zone;
when a preceding vehicle starts after the vehicle stops, determining whether the time limit for automatic start has been set; and
when it is determined that the time limit for automatic start has been set, controlling a start of the vehicle based on the time limit for automatic start

20. The start control method according to claim 19, further comprising:
when the preceding vehicle starts after the vehicle stops, determining whether the time limit for automatic start has elapsed from a point that the vehicle stopped,
wherein controlling the start of the vehicle comprises:
when it is determined that the time limit for automatic start has elapsed from the point that the vehicle stopped, holding the start of the vehicle; and
when it is determined that the time limit for automatic start has not elapsed from the point that the vehicle stopped, controlling the start of the vehicle based on a distance between the vehicle and the preceding vehicle.
